(19) United States
(12) Patent Application Publication
(10) Pub. No.: US 2024/0074005 A1
(43) Pub. Date: Feb. 29, 2024

(54) METHOD FOR TREATING A LIQUID, IN PARTICULAR AN AQUEOUS LIQUID, WITH A VIEW TO HEATING SAME, GENERATING STEAM, DEVELOPING A CATALYTIC REACTION, PRODUCING NANOPARTICLES AND/OR CONCENTRATING AT LEAST ONE SPECIES PRESENT THEREIN

(71) Applicant: HOLOPHARM, EVREUX (FR)

(72) Inventors: Pierre Marie MONDIN, EVREUX (FR); Julien MORVAN, EVREUX (FR)

(21) Appl. No.: 18/271,543

(22) PCT Filed: Jan. 10, 2022
(86) PCT No.: PCT/EP2022/050357

§ 371 Date: Jul. 10, 2023

(30) Foreign Application Priority Data
Jan. 12, 2021 (FR) FR2100254

(51) Int. Cl. H05B 3/60

(52) U.S. Cl. CPC H05B 3/60; H05B 2203/021

(57) ABSTRACT

Method for treating a liquid with a view to heating same, generating steam, developing a catalytic reaction and/or concentrating at least one species present therein, wherein a flow of a liquid is caused to circulate in at least one treatment area formed between at least two electrodes connected to an alternating current source with a phase alternation frequency greater than or equal to

### TECHNICAL FIELD

The present invention relates to processes for treating a liquid with a view to heating it, producing steam, developing a catalytic reaction, producing nanoparticles and/or concentrating at least one species present therein.

### PRIOR ART

FR 3036467 describes a liquid heating device including two electrodes and a power supply applying an alternating current of 220 V and 50 Hz between the two electrodes.

WO 2009/049194 discloses a device for generating hot water for domestic heating facilities, the device including metal electrodes, notably made of steel, supplied with an alternating current of 60 Hz and 120 V or 220/240 V.

EP 2394965 describes a device for purifying/decontaminating water by electrolysis, including electrodes supplied with three-phase current. It is reported therein that the electrodes are made of a porous material so as to maintain a high level of electrolysis.

The above devices produce a non-negligible amount of hydrogen and oxygen by electrolysis, which poses problems of evacuation of these gases due to the risk of explosion at certain concentrations.

### DISCLOSURE OF THE INVENTION

The invention is directed toward proposing a process for treating a liquid, which is notably aqueous, with a view to heating it, producing steam, developing a catalytic reaction, producing nanoparticles and/or concentrating at least one species therein, which allows the electrolysis of water and the production of hydrogen and oxygen associated with this electrolysis to be reduced or even eliminated.

### SUMMARY OF THE INVENTION

Process for Treating a Liquid, which is Notably Aqueous, with a View to Heating Same, Producing Steam, Developing a Catalytic Reaction, Producing Nanoparticles and/or Concentrating at Least One Species Present Therein

According to the invention, a liquid, which is notably aqueous, is exposed or a flow of a liquid is circulated in at least one treatment zone formed between at least two electrodes connected to an alternating current source with a phase alternation frequency greater than or equal to 100 Hz, so as to heat, vaporize, chemically activate, produce nanoparticles and/or concentrate the liquid at least partially under the effect of the passage of current between these electrodes.

A flow of a liquid may notably be circulated in at least one treatment zone formed between at least two electrodes connected to an alternating current source with a phase alternation frequency greater than or equal to 100 Hz, so as to heat, vaporize, chemically activate and/or concentrate the liquid at least partially under the effect of the passage of the current between these electrodes.

An aqueous liquid, notably containing one or more metal salts, may also be exposed to at least one treatment zone formed between at least two electrodes, connected to an alternating current source with a phase alternation frequency greater than or equal to 100 Hz, so as to produce nanoparticles under the effect of the current passing between these electrodes.

The Applicant has found that the process according to invention may, surprisingly, significantly reduce, or even eliminate, the production of undesirable gas(es), in particular those produced by electrolysis such as hydrogen (H₂) and oxygen (O₂), for example, when the liquid is aqueous.

The process according to the invention may also, surprisingly, allow instant and continuous vaporization of the flow of liquid, which is notably aqueous, passing through the treatment zone. This is possible when the temperature of the liquid entering the treatment zone is greater than or equal to 0° C. This means that the process according to the invention may allow instant and continuous vaporization of a liquid flow whose temperature is between 0° C. and 10° C., which is particularly noteworthy. The invention may also allow the vaporization of liquids which are brought into the treatment zone at a temperature below 0° C., and which are under a pressure which allows them to remain liquid at this temperature.

The process according to the invention may allow the production of nanoparticles.

The process according to the invention is also robust and energy-efficient.

Treatment Zone

The treatment zone may be formed between at least two electrodes supplied with single-phase current.

As a variant, the treatment zone is formed between at least three electrodes supplied with multi-phase, preferably three-phase, current, even more preferentially with phase balance. In this case, the process according to the invention is more energy-efficient than an electric resistance heater for steam generation applications.

The treatment zone may be formed between three electrodes arranged in a balanced triangular lattice, or between six electrodes arranged as the vertices of an equilateral triangle and halfway along the sides, or arranged as a hexagon.

The current may flow between at least two electrodes, including a neutral electrode placed in the treatment zone. The neutral electrode may be made of a ferromagnetic material. This may allow the magnetic field generated by the current passing in the treatment zone to be more concentrated. The ferromagnetic material may or may not be covered with an insulating material and/or may or may not be connected to the alternating current source, depending on whether or not it is desired to modify the magnetic and/or electric field.

Electrodes

The electrodes may be made of any electrically conductive material, for example graphite, a metallic material, notably iron, steel, stainless steel, titanium, gold, copper, or a non-metallic conductive material, notably based on polymers or semiconductors such as metalloids. The fact that the electrodes are connected to a source of alternating current with a phase alternation frequency greater than or equal to 100 Hz enables the oxidation of the electrodes to be limited, in addition to limiting water electrolysis as previously mentioned.

Preferably, the electrodes are made of a material that is chemically inert with respect to the liquid being treated.

Preferably, the electrodes are made of graphite.

The electrodes may include electrically insulated portions and non-insulated portions, the non-insulated portions defining electrical dipoles arranged in a three-dimensional lattice superimposable by scaling on a simple cubic, face-centered cubic, “Blende”-type or hexagonal crystalline lattice. An insulated portion of an electrode is obtained, for example, by using an insulating sheath surrounding the electrode.

The use of metal electrodes may allow the formation of metal salts and/or spherules, notably colloidal metal particles. For example, steel, titanium or gold electrodes are used to allow the formation of iron oxides, titanium oxides or gold microspherules, respectively.

The use of a metal electrode may allow the production of nanoparticles of this metal.

The electrodes may be tubular, spherical, cylindrical or plate-shaped.

The length of the electrodes may be between 1 μm and 1 m. For example, the electrodes are 10 cm long.

The electrodes may be arranged in parallel or closer together towards the top of the treatment zone, so as to form a pyramid or cone shape, for example.

The distance between two electrodes may be chosen according to the desired electric field. It may be between 1 μm and 1 m.

Liquid

The liquid may be aqueous or non-aqueous. When non-aqueous, the liquid is, for example, liquid hydrogen or another liquefied gas.

Circulation of the liquid, notably aqueous, flow in the treatment zone may be performed by any means, notably using a pump, notably a peristaltic, centrifugal or volumetric pump. As a variant, circulation of the liquid flow in the treatment zone is performed by gravity.

The aqueous liquid may be chosen from more or less mineralized or polluted water, and more generally from an aqueous solution, an aqueous suspension, an aqueous emulsion or an aqueous sludge.

The process according to the invention may allow the liquid to be heated. The liquid to be heated is, for example, water circulating in a heating circuit, or a liquefied gas which it is sought to vaporize very rapidly.

The Applicant has found that the process according to invention may allow the purification of an aqueous liquid by degradation of organic molecules contained in the aqueous liquid. The aqueous liquid leaving the treatment zone or the condensates resulting from the condensation of the steam produced by the process then correspond, respectively, to a purified aqueous liquid or to purified water.

The aqueous liquid may include one or more organic molecules, notably aromatic molecules, endocrine disruptors, hydrocarbons and/or pollutants. For example, the organic molecules are Triton X-100, L-methionine, medroxyprogesterone acetate, methyl para-hydroxybenzoate and/or gentian violet.

The aqueous liquid to be purified may be an aqueous effluent from an industrial unit, notably industrial waste water, or it may be domestic waste water containing various types of pollutants, notably organic, presenting more or less dangerous toxicity and thus environmental and health risks.

The aqueous liquid to be purified may also be raw water, notably from a well, borehole or spring, which is intended for distribution in drinking water circuits.

The present invention may thus allow waste water to be purified prior to discharge into the natural environment or reuse, or may allow raw water to be made drinkable.

For such a purification application, the electrodes are preferably made of a non-oxidizable, chemically inert conductive material, in particular graphite. This allows the aqueous liquid to be purified, which flows through the treatment zone, to be prevented from being polluted with elements originating from the electrode material, notably via the release of metal ions in the case of electrodes made of a metallic material.

The process according to the invention may allow the aqueous liquid to be concentrated. The aqueous liquid to be concentrated is, for example, seawater or hard water. The Na⁺ and Cl⁻ ions of seawater or the CO₃²⁻, Cl⁻, Ca²⁺ and Mg²⁺ ions of hard water are concentrated in the aqueous liquid within the treatment zone, and the condensates correspond to fresh water.

The aqueous liquid may contain metal ions which react with the electrodes to form metal nanoparticles.

Electric Field

The passage of current through the treatment zone may generate a rotating and/or oscillating electric field. This electric field may generate a magnetic field which is oscillating and oriented perpendicular to the electric field.

The electric field, and notably the magnetic field, may generate Cooper pairs.

At least one ferromagnetic core may be present within the treatment zone. The ferromagnetic core may or may not be electrically insulated. In particular, it may or may not be connected to the neutral electrode.

The alternating current source may have a phase alternation frequency greater than or equal to 200, 300, 400, 500, 1000, 2000, 3000, 5000, 10 000, 15 000 or 20 000 Hz, preferably greater than or equal to 300, 1000 or 20 000 Hz, and preferably less than or equal to 2 MHz, better still less than or equal to 1.6 MHz. The Applicant has found that the use of a phase alternation frequency greater than or equal to 300 Hz allows a further reduction in the production of gases, in particular those produced by electrolysis, and a further reduction in electrode oxidation. For example, the alternating current source has a phase alternation frequency equal to 3 kHz, 1.3 MHz or 1.6 MHz. Preferably, the alternating current source has a phase alternation frequency of between 1 and 50 kHz.

The electrode supply current may or may not be a chopped current. In the case where the electrode supply current is a chopped current, it is preferably chopped at a frequency of between 1 and 100 kHz. Chopping the current may make it possible to improve the performance of the process, notably by allowing control of the waveform of the alternating current supplying the electrodes.

The chopping frequency may be strictly equal to twice the phase alternation frequency. This may allow resonance to be induced in the treatment zone and thus improve the performance of the process.

The chopping frequency may be strictly greater than twice the phase alternation frequency. This may allow resonance to be induced in the treatment zone and thus contribute toward improving the performance of the process, without this resonance mechanically damaging the electrodes.

The dry no-load voltage between electrodes is chosen according to the desired electric field. It may be greater than or equal to 1 nV, better still between 20 and 600 V, depending on the distance between the electrodes. The electric field intensity may be greater than or equal to 1 V/m, and preferably less than or equal to 1 MV/cm.

The voltage applied between the electrodes may be chosen so as to generate electric arcs and/or plasma, preferably continuously, in the liquid within the treatment zone. Preferably, these electric arcs and/or plasmas are formed along the electrodes and not between the electrodes. These arcs or plasmas are readily visible as they emit blue, pink, violet or orange light within the treatment zone. The presence of these arcs or plasmas may allow the energy efficiency of the process according to the invention to be improved.

At least part of the heat generated by the process, notably at least part of the latent heat of condensation of the steam produced and/or at least part of the steam produced and/or at least part of the liquid heated after passing through the treatment zone and/or at least part of the heat generated within the treatment zone, may be used to heat the liquid upstream of and/or within the treatment zone or to heat, or even vaporize, a fluid different from the liquid. For example, one or more heat exchangers may be used for this purpose.

Reactor

The treatment zone may be located in a reactor with an inlet allowing aqueous liquid to be fed into the treatment zone, and an outlet allowing heated aqueous liquid and/or steam to exit the treatment zone.

For steam production applications, the reactor outlet may be connected to an overflow allowing recovery of the non-vaporized part of the liquid, notably liquid splashes at the reactor outlet.

The reactor may be spherical or tubular, for example with a circular or polygonal cross-section. For example, the reactor is a tube with a polygonal cross-section, notably square, rectangular or triangular. In the case where the treatment zone is formed between three electrodes arranged in a balanced triangular lattice, the use of a tubular reactor with a triangular cross-section is advantageous, for example, as it may allow dead volumes between the balanced triangular lattice of the treatment zone and the reactor walls to be limited.

The reactor is preferably made of a chemically inert and heat-resistant material, notably metal, for example stainless steel, glass, ceramic or polytetrafluoroethylene (PTFE).

The reactor may be multi-jacketed, notably double-jacketed, and at least some of the aqueous liquid heated after passing through the treatment zone, at least some of the steam generated and/or at least some of the condensate may flow through it to heat the liquid in the treatment zone. As a variant, at least some of the liquid to be treated is circulated in the multi-jacket, notably the double jacket, so as to be reheated by at least some of the heat generated within the treatment zone.

The liquid flow rate through the treatment zone may be greater than or equal to 0.0001 mL/min/W delivered by an electric generator supplying the electrodes, better still greater than or equal to 0.0003 mL/sec/W delivered, for example greater than or equal to 1 mL/sec, notably greater than or equal to 1 L/min. For example, the liquid flow rate through the treatment zone is between 1 and 100 L/min or even more, depending on the electrical power supplied.

The liquid may be heated and/or vaporized in an open circuit.

As a variant, the liquid is heated and/or vaporized in a closed circuit. In this case, the heated liquid and/or condensates are re-injected into the treatment zone. The process may be performed cyclically in a closed circuit, with fresh liquid supplied/treated liquid discharged between each cycle. In cases where the liquid is heated and/or vaporized in a closed circuit, the liquid is preferably deionized or even purified water or aqueous ammonia. This may allow the integrity of the materials used in the process to be preserved, notably the materials constituting the electrodes, the reactor, the pipework and the heat exchanger(s), where applicable. Damage to the materials, notably by oxidizing and/or corrosive agents, is thus limited, allowing their service life to be extended.

Process for Treating a Liquid, which is Notably Aqueous, with Recovery of the Treated Liquid

A subject of the invention, independently or in combination with the foregoing, is also a process for treating a liquid, which is notably aqueous, in which the liquid is heated and/or vaporized by performing the process as defined above, and the liquid which has circulated through the treatment zone and/or the condensates are recovered as the treated liquid.

The liquid may be an aqueous liquid, notably seawater or hard water, in which the condensates are recovered.

In one variant, the aqueous liquid is an effluent to be depolluted or a raw water to be made drinkable.

In another variant, the liquid, which is notably aqueous, includes one or more carbon compounds to be cracked and/or destroyed and/or rearranged. For example, the process according to the invention may make it possible, using graphite electrodes, to treat under positive pressure (from 1 to 5 cm of water) within the treatment zone a deionized and purified water solution with sodium carbonate (Na₂CO₃) as electrolyte at a concentration of 5×10⁻³ M in order to obtain, within 5 hours, carbon compounds, for instance carbon monoxide (CO), carbon dioxide (CO₂) and traces of hydrocarbons, notably alkanes (for example methane, ethane, propane, isobutane, butane, isopentane, pentane), alkenes (for example ethylene, propene, isobutene) or alkynes (for example acetylene). These carbon compounds may be detected by gas chromatography, notably coupled with a catharometer.

The process may be sequential, with at least one sequence of heating the liquid and/or producing steam, followed by at least one sequence of emptying the treatment zone. This is particularly suitable for applications such as seawater desalination or hard water softening.

The electrical conductivity of the liquid, which is notably aqueous, feeding or in the treatment zone may be measured, and draining of the reactor triggered when the conductivity exceeds a predefined threshold.

Electricity Production Process

A subject of the invention, independently or in combination with the foregoing, is also a process for producing electricity, in which the liquid, which is notably aqueous, is heated and/or vaporized by performing the process as defined above, and in which the heated liquid and/or the vapor produced are used to drive an electric generator.

This electric generator may be a Stirling engine connected to an alternator, or a turbine connected to an alternator.

Facility

A subject of the invention, independently or in combination with the foregoing, is also a facility, notably for performing the process according to the invention, including:
a reactor including at least one supply of a liquid, which may be aqueous or non-aqueous, having at least one treatment zone in which the liquid may circulate, preferably in a continuous flow,
at least two electrodes arranged in the treatment zone for exposing the liquid therein to an alternating electric current with a phase alternation frequency greater than or equal to 100 Hz, so as to heat, vaporize, chemically activate and/or concentrate the liquid at least partially under the effect of the current passing between these electrodes,
an electric generator to supply the electrodes with alternating current with a phase alternation frequency equal to or greater than 100 Hz.

Such a facility may have some or all of the features presented above.

In particular, the electric generator may be configured to generate an alternating current with a phase alternation frequency greater than or equal to 200, 300, 400, 500, 1000, 2000, 3000, 5000, 10 000, 15 000 or 20 000 Hz, preferably greater than or equal to 300, 1000 or 20 000 Hz, and preferably less than or equal to 2 MHz, better still less than or equal to 1.6 MHz. Preferably, the electric generator is configured to generate an alternating current with a phase alternation frequency of between 1 and 50 kHz.

The electric generator may be configured to generate a chopped alternating current, preferably at a chopping frequency of between 1 and 100 kHz.

The electric generator may be configured to generate single-phase or multi-phase alternating current, preferably three-phase, even more preferentially with phase balance.

The electric generator may be configured to allow the voltage to be limited to a desired value, notably to prevent breakdown between the dry electrodes.

The facility may include at least one energy recovery system configured to allow condensation of at least part of the vapor produced, recovery of at least part of the latent heat of condensation and use of at least part of the recovered latent heat of condensation to heat the liquid upstream of and/or within the treatment zone, or to heat or even vaporize a fluid different than the liquid.

The facility may include a liquid/vapor separator downstream of the treatment zone.

A subject of the invention, independently or in combination with the foregoing, is also a process for treating a liquid, which is notably aqueous, with a view to heating it, producing vapor, triggering a catalytic reaction and/or concentrating at least one species present therein, in which a flow of the liquid is circulated in at least one treatment zone formed between at least two electrodes connected to a source of alternating current, so as to heat, vaporize, chemically activate and/or concentrate the liquid at least partially under the effect of the passage of the current between these electrodes, and in which at least part of the heat generated by the process, notably at least part of the latent heat of condensation of the vapor produced and/or at least part of the steam produced and/or at least part of the liquid heated after passing through the treatment zone and/or at least part of the heat generated within the treatment zone, is used to heat the liquid upstream of and/or within the treatment zone or to heat or vaporize a fluid different from the liquid.

The alternating current source may have a phase alternation frequency greater than or equal to 100 Hz, notably greater than or equal to 200, 300, 400, 500, 1000, 2000, 3000, 5000, 10 000, 15 000 or 20 000 Hz, preferably greater than or equal to 300, 1000 or 000 Hz, and preferably less than or equal to 2 MHz, better still less than or equal to 1.6 MHz. Preferably, the alternating current source has a phase alternation frequency of between 1 and 50 kHz.

The electrode supply current may or may not be a chopped current. In the case where the electrode supply current is a chopped current, it is preferably chopped at a frequency of between 1 and 100 kHz.

The treatment zone may be located in a multi-jacketed reactor, notably a double-jacketed reactor, and at least some of the liquid, notably aqueous liquid, heated after passing through the treatment zone, at least some of the vapor produced and/or at least some of the condensates may flow through it to heat the liquid in the treatment zone. As a variant, at least some of the liquid to be treated is circulated in the multi-jacket, notably the double jacket, so as to be reheated by at least some of the heat generated within the treatment zone.

A subject of the invention, independently or in combination with the foregoing, is also a facility, notably for performing the process as defined above, including:
a reactor including at least one liquid supply, with at least one treatment zone in which the liquid can notably flow continuously,
at least two electrodes arranged in the treatment zone for exposing the liquid therein to an alternating electric current so as to heat, vaporize, chemically activate, produce nanoparticles and/or concentrate the liquid at least partially under the effect of the passage of the current between these electrodes,
an electric generator to supply the electrodes with alternating current,
at least one energy recovery system configured to allow condensation of at least part of the vapor produced, recovery of at least part of the latent heat of condensation and use of at least part of the recovered latent heat of condensation to heat the liquid upstream of and/or within the treatment zone or to heat or vaporize a fluid different from the liquid.

The electric generator may be configured to generate an alternating current with a phase alternation frequency greater than or equal to 100 Hz, notably greater than or equal to 200, 300, 400, 500, 1000, 2000, 3000, 5000, 10 000, 15 000 or 20 000 Hz, preferably greater than or equal to 300, 1000 or 20 000 Hz, and preferably less than or equal to 2 MHz, better still less than or equal to 1.6 MHz. Preferably, the electric generator is configured to generate an alternating current with a phase alternation frequency of between 1 and 50 kHz.

The electric generator may be configured to generate a chopped alternating current, preferably at a chopping frequency of between 1 and 100 kHz.

The electric generator may be configured to generate single-phase or multi-phase alternating current, preferably three-phase, even more preferentially with phase balance.

The electric generator may be configured to allow the voltage to be limited to a desired value, notably so as to prevent breakdown between the dry electrodes.

The reactor may be multi-jacketed, notably double-jacketed, and at least some of the liquid heated after passing through the treatment zone, at least some of the vapor generated and/or at least some of the condensates may flow through it to heat the liquid in the treatment zone. As a variant, at least some of the liquid to be treated is circulated in the multi-jacket, notably the double jacket, so as to be heated by at least some of the heat generated within the treatment zone.

Production of Nanoparticles

Preferably, for nanoparticle production, the inter-electrode voltage is between 10 V and 680 V, and the alternating electric current has a phase alternation frequency greater than or equal to 100 Hz, with waveforms that are, for example, square, sinusoidal, triangular, etc.).

The term “nanoparticles” denotes particles smaller than one micron, better still 100 nm. The nanoparticles may be metallic.

The medium, which is notably aqueous, to be treated in the treatment zone contains one or more metal salts, for example copper sulfate, iron sulfate, silver nitrate, etc.

The substance(s) allowing the electrochemical reactions to take place may be pre-introduced into the treatment zone, or may be fed into the treatment zone in a continuous stream using a pump.

The formation of the nanoparticles is virtually instantaneous. The nanoparticles are notably present:
on the surface of the electrodes,
on the walls of the treatment zone,
in the residual concentrate of the treated medium, and
in the steam produced.
   A substrate on which the nanoparticles are to be deposited may be exposed to the nanoparticle-laden vapor produced. The substrate may be made of a semiconductor material, for example silicon.
   The production of nanoparticles may correspond to at least 10%, better still at least 20%, by mass of the metal introduced, for example at least 10% by mass of Ag nanoparticles for a given mass of Ag introduced in ionic form within AgNO₃.

### BRIEF DESCRIPTION OF THE DRAWINGS

The invention may be understood more clearly on reading the following detailed description of nonlimiting implementation examples thereof, and on examining the appended drawing, in which:

FIG. 1 represents an example of an AC waveform that can power electrodes according to the invention,

FIG. 2 represents another example of an AC waveform that can power the electrodes,

FIG. 3 represents another example of an AC waveform that can power the electrodes,

FIG. 4 represents another example of an AC waveform that can power the electrodes,

FIG. 5 represents another example of an AC waveform that can power the electrodes,

FIG. 6 represents another example of an AC waveform that can power the electrodes,

FIG. 7 represents another example of an AC waveform that can power the electrodes,

FIG. 8 represents another example of an AC waveform that can power the electrodes,

FIG. 9 is a longitudinal section of an example of a single-phase AC-powered electrode arrangement,

FIG. 10 is a cross-section of another example of a single-phase AC-powered electrode arrangement,

FIG. 11 is a longitudinal section of the example shown in FIG. 10,

FIG. 12 is a longitudinal section of an embodiment variant of the example shown in FIGS. 10 and 11,

FIG. 13 is a cross-section of another example of a single-phase AC-powered electrode arrangement,

FIG. 14 is a cross-section of another example of a single-phase AC-powered electrode arrangement,

FIG. 15 is a cross-section of another example of a single-phase AC-powered electrode arrangement,

FIG. 16 is a cross-section of another example of a single-phase AC-powered electrode arrangement,

FIG. 17 is a partial schematic perspective view of an example of a single-phase AC-powered electrode arrangement in a face-centered cubic crystal lattice,

FIG. 18 is a partial schematic perspective view of an example of a single-phase AC-powered electrode arrangement in a simple cubic crystal lattice,

FIG. 19 is a partial schematic perspective view of an example of a single-phase AC-powered electrode arrangement in a “blende”-type crystal lattice,

FIG. 20 is a cross-section of an example of a multi-phase AC-powered electrode arrangement,

FIG. 21 is a cross-section of another example of a multi-phase AC-powered electrode arrangement,

FIG. 22 is a cross-section of another example of a multi-phase AC-powered electrode arrangement,

FIG. 23 is a cross-section of another example of a multi-phase AC-powered electrode arrangement,

FIG. 24 is a cross-section of another example of a multi-phase AC-powered electrode arrangement,

FIG. 25 is a cross-section of another example of a multi-phase AC-powered electrode arrangement,

FIG. 26 is a cross-section of another example of a multi-phase AC-powered electrode arrangement,

FIG. 27 is a cross-section of another example of a multi-phase AC-powered electrode arrangement,

FIG. 28 is a cross-section of another example of a multi-phase AC-powered electrode arrangement,

FIG. 29 is a schematic view of a vapor production process using an immersion heater,

FIG. 30 is a schematic view of a vapor production process according to the invention,

FIG. 31 is a schematic view of a reactor according to the invention,

FIG. 32 is a cross-section of the reactor shown in FIG. 31, along sectional plane I-I,

FIG. 33 is a schematic view of an open-circuit vapor production process according to the invention,

FIG. 34 is a schematic view of a closed-circuit vapor production process according to the invention,

FIG. 35 is a schematic view of an embodiment variant of the process shown in FIG. 34,

FIG. 36 is a schematic view of an embodiment variant of the process shown in FIG. 33, and

FIG. 37 is a schematic view of an embodiment variant of the process shown in FIG. 34.

### DETAILED DESCRIPTION

Waveforms of the Alternating Current that can Power the Electrodes

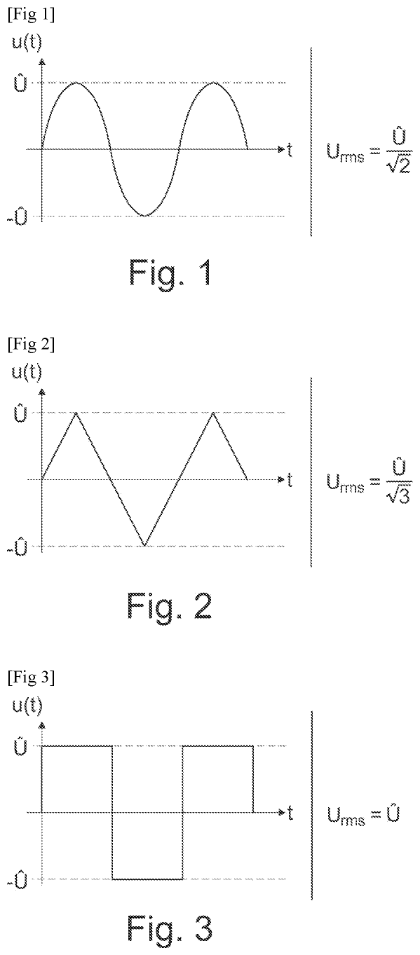

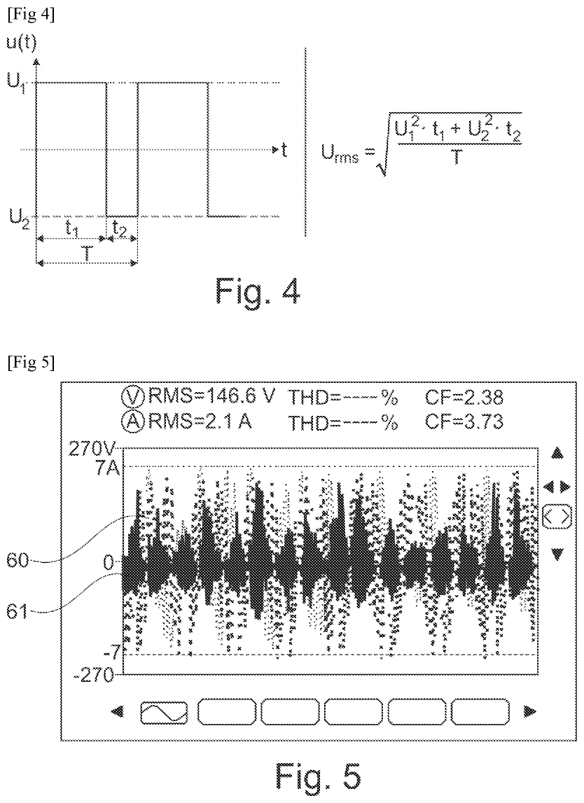

The alternating current powering the electrodes may be sinusoidal, triangular, square or square with offset and duty cycle 50%, as illustrated in FIGS. 1 to 4, respectively.

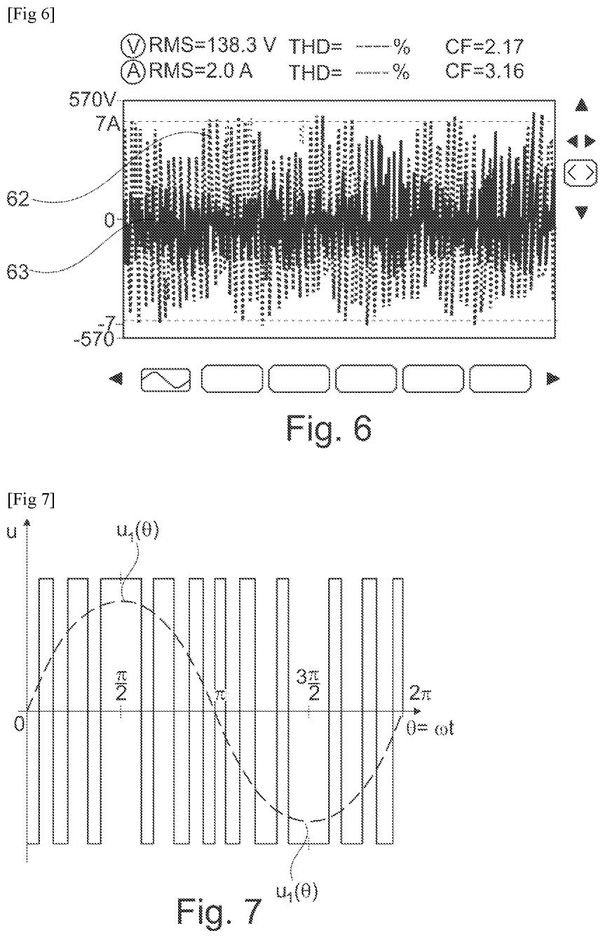

The alternating current supplying the electrodes may have a waveform as represented in FIGS. 5 and 6. In FIG. 5, components 60 and 61 represent 146.6 V RMS and 2.1 A, respectively, and in FIG. 6, components 62 and 63 represent 138.3 V RMS and 2.0 A, respectively.

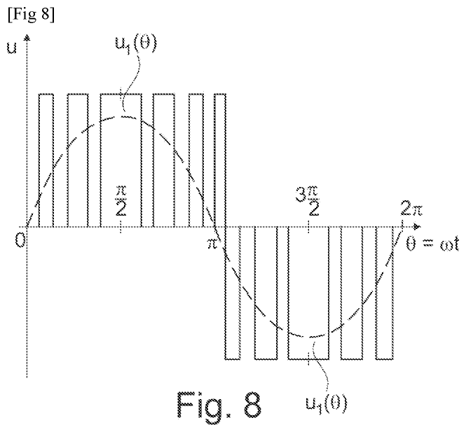

The alternating current powering the electrodes may also be a pulse width modulation (PWM) wave of the full-wave type (also known as bipolar), as shown in FIG. 7, or of the half-wave type (also known as unipolar), as shown in FIG. 8.

Single-Phase AC-Powered Electrodes

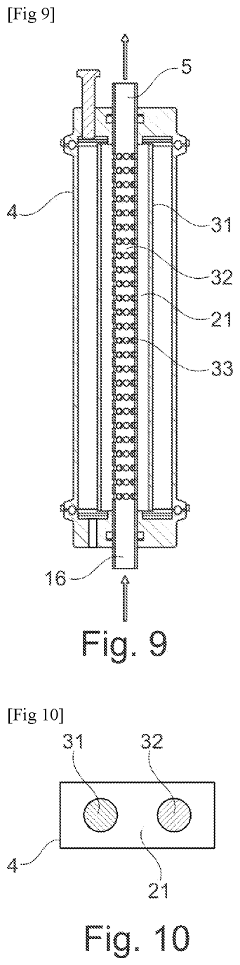

FIG. 9 shows an example of an arrangement of single-phase AC-powered electrodes 31, 32, viewed in longitudinal section.

In this example, the reactor 4 includes a treatment zone 21 formed between two concentric tubular electrodes 31, 32: a neutral electrode 32 and a phase electrode 31, with the neutral electrode 32 having a smaller diameter than the phase electrode 31.

The circulation of liquid for example within the reactor 4 is described hereinbelow. The liquid is injected into the neutral electrode 32 at the inlet 16 of the reactor 4. The liquid then enters zone 21 through orifices 33 in the neutral electrode 32, so as to be heated or even vaporized. The heated liquid, or even the vapor generated, then returns to the interior of the phase electrode 32 through the orifices 33 so as to exit the reactor 4 at its outlet 5.

The single-phase AC-powered electrodes 31, 32 may have other shapes, for example cylindrical, spiral or plate-shaped, and may be arranged differently within the reactor 4.

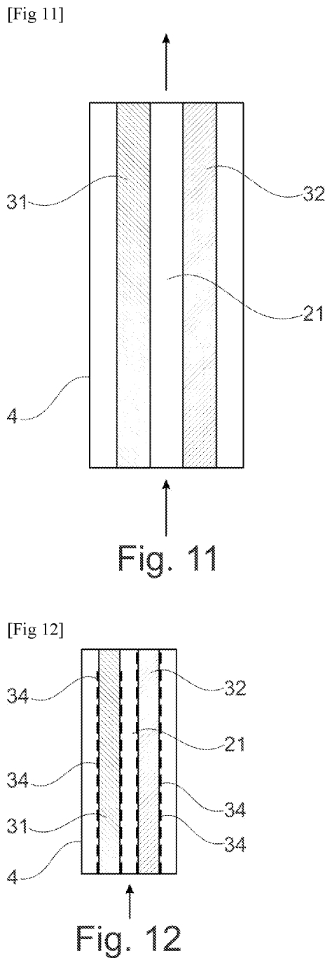

For example, the reactor 4 may include a treatment zone 21 formed between two cylindrical electrodes 31, 32—a neutral electrode 32 and a phase electrode 31—as illustrated in FIGS. 10 and 11. As a variant, the electrodes 31, 32 are partially insulated. For this purpose, an insulator 34 may partially cover the electrodes 31, 32 along their length, as shown in FIG. 12.

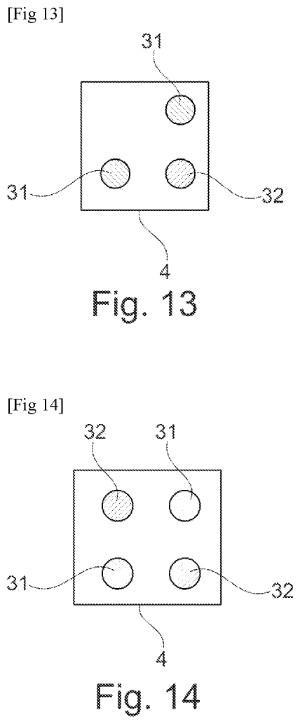

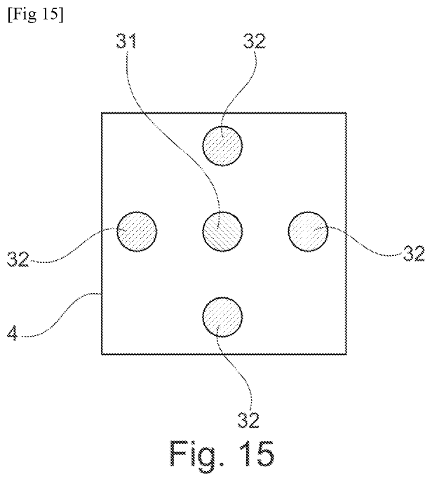

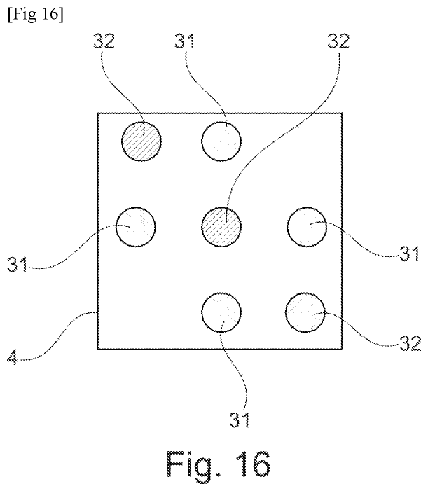

The treatment zone 21 may be formed between more than two single-phase AC-powered electrodes 31, 32. For example, zone 21 may be formed between three (one neutral electrode 32 and two phase electrodes 31, or vice versa), four (two neutral electrodes 32 and two phase electrodes 31), five (four neutral electrodes 32 and one phase electrode 31, or vice versa) or seven (three neutral electrodes 32 and four phase electrodes 31, or vice versa) notably cylindrical electrodes, according to the arrangements illustrated in FIGS. 13 to 16, respectively. The phase 31 and neutral 32 electrodes represented in these figures are, of course, interchangeable.

In the case where the electrodes are powered by a single-phase alternating current, the latter preferably has a phase alternation frequency of between 1 and 50 kHz. It may or may not be chopped, notably with a chopping frequency of between 1 and 100 kHz.

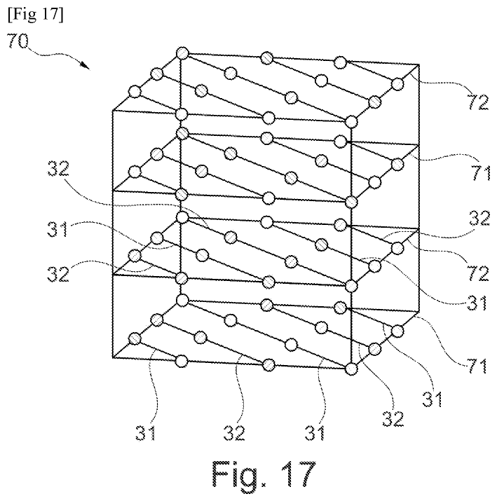

FIGS. 17 to 19 show examples of the arrangement of single-phase AC-powered electrodes in crystal lattices.

FIG. 17 represents an example of an arrangement 70 of electrodes in a face-centered cubic crystal lattice. Arrangement 70 includes alternating parallel and equidistant electrode planes 71, 72. The planes 71 include alternating parallel and equidistant phase 31 and neutral 32 electrodes. The planes 72 correspond to the planes 71 in which the phase 31 and neutral 32 electrodes are interchanged. The distance between two adjacent electrodes within a plane is equal to the distance between two adjacent planes.

The phase electrodes 31 and neutral electrodes 32 may be conductive over their entire length or partially insulated. In this example, the phase 31 and neutral 32 electrodes are partially insulated, so that conductive portions (represented by spheres) alternate with insulated portions (represented by segments).

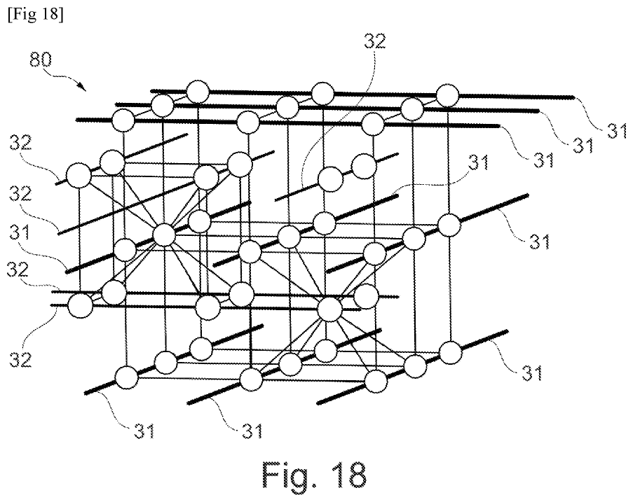

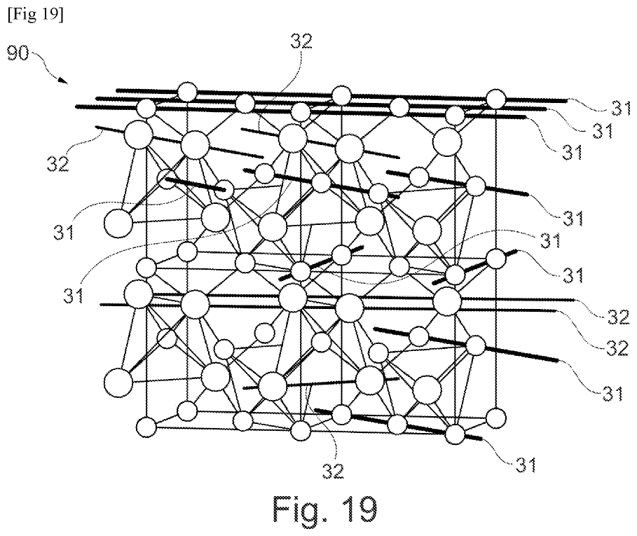

FIGS. 18 and 19 respectively represent an example of an electrode arrangement 80 based on a simple cubic crystal lattice and an example of an electrode arrangement 90 based on a “blende” crystal lattice, each including partially insulated phase 31 and neutral 32 electrodes.

Multi-Phase AC-Powered Electrodes

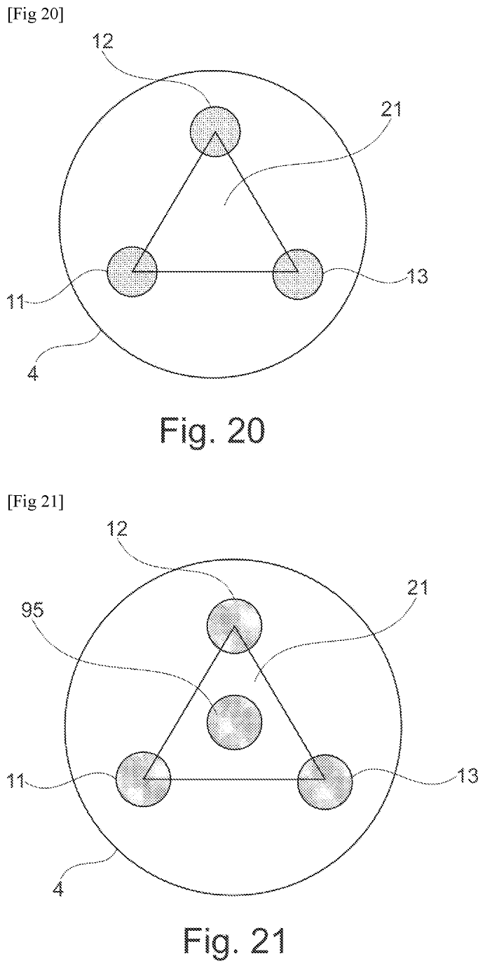

Preferably, the AC-powered phase electrodes 11, 12, 13 each occupy one of the vertices of an equilateral triangle when viewed in cross-section, so as to form a triangular elementary lattice, as illustrated in FIG. 20. As a variant, a neutral electrode 95 may occupy the center of the equilateral triangle, as shown in FIG. 21.

The phase electrodes 11, 12, 13 and neutral electrode 95 may be made of any conductive material.

A ferromagnetic core (not represented) may be included within the lattice of electrodes 11, 12, 13 and/or 95. For example, the neutral electrode 95 may be made of a ferromagnetic material or include a ferromagnetic core optionally covered with an insulating material. As a variant, the ferromagnetic core is not connected to the neutral electrode 95 and may or may not be covered with an insulating material.

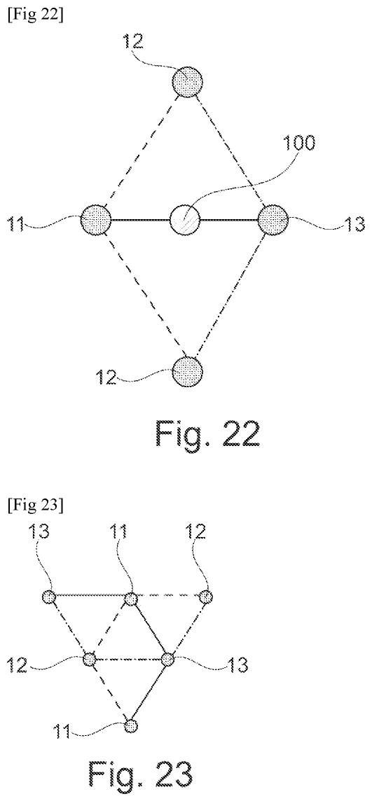

In order to vary the strength of the rotating and/or oscillating electric field within the treatment zone 21, the size of the lattice formed by the equilateral triangle may be varied, or the lattice may be repeated, as illustrated in FIGS. 22 to 28.

As shown in FIG. 22, the reactor may include four phase electrodes 11, 12, 13 arranged in two lattices and an insulated ferromagnetic core 100 arranged in the center of the space formed between the electrodes 11, 12, 13.

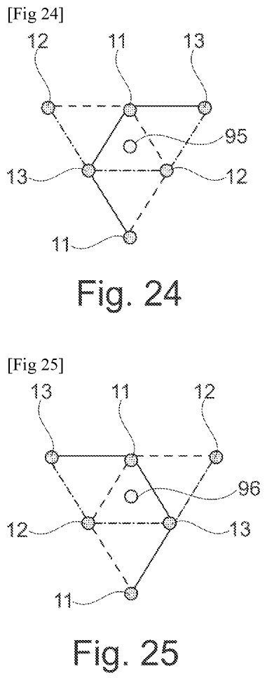

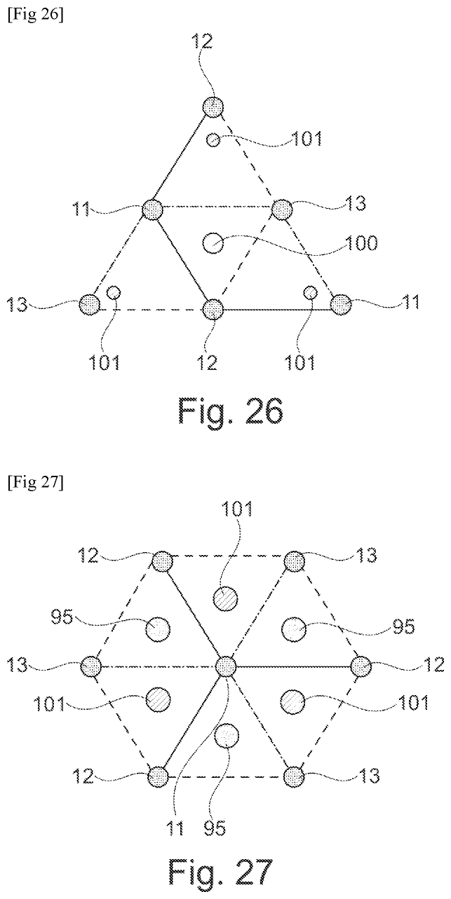

As shown in FIG. 23, the reactor may include six phase electrodes 11, 12, 13 arranged in four lattices to form a triangle. As a variant, a neutral electrode 95 (FIG. 24) or a neutral electrode 96 including an insulated ferromagnetic core (FIG. 25) is present at the center of gravity of the triangle formed by the four lattices. In another variant, an insulated ferromagnetic core 100 is arranged at the center of gravity of the triangle formed by the four lattices, and three non-insulated ferromagnetic cores 101 are arranged within this triangle, each close to one of its vertices (FIG. 26).

As shown in FIG. 27, the reactor may include seven phase electrodes 11, 12, 13 arranged in six lattices to form a hexagon. Three neutral electrodes 95 and three insulated ferromagnetic cores 100 are arranged at the center of gravity of the lattices.

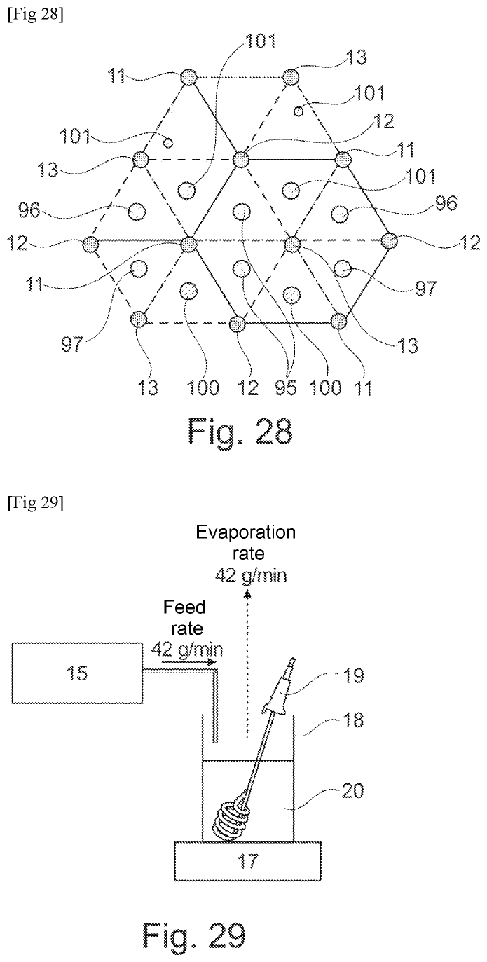

As shown in FIG. 28, the reactor may include 12 phase electrodes 11, 12, 13 arranged in thirteen lattices to form a polygon. Insulated ferromagnetic cores 100, non-insulated ferromagnetic cores 101, neutral electrodes 95, neutral electrodes 96 including an insulated ferromagnetic core and ferromagnetic neutral electrodes 97 are included within the polygon.

Comparative Test for Vapor Production Applications

In this comparative test, the energy efficiency of the process according to the invention was compared with that of an electric immersion heater 19, for vapor production applications.

The immersion heater 19 used has the following characteristics: power of 2000 W; single-phase AC-powered at a voltage of 220 V; length of 70 mm; diameter of 58 mm; total length of 310 mm.

As shown in FIG. 29, the immersion heater 19 is immersed in a polyethylene beaker 18 (5 L capacity and 165 mm diameter) containing 3500 mL of tap water 20 with a conductivity of 620 μS/cm, so as to heat the tap water 20 to the boiling point while producing a constant evaporation rate. The beaker 18 is placed on a Sartorius BP4100 type balance 17, allowing the evaporation rate (in g/min) of the tap water 20 contained in the beaker 18 to be determined.

When the evaporation rate becomes constant, the beaker 18 is fed with tap water through a peristaltic pump 15 of the Hirshmann Rotarus PK10-16 type at a feed rate corresponding to the constant evaporation rate determined, so that the weight of the beaker 18 containing the tap water 20 is constant over time.

The constant evaporation rate determined using the balance 17 is 42 g/min.

For a temperature close to 42° C. for the tap water feeding the beaker 18 (KIMO KISTOCK KTT 310 thermometer with type K thermocouple probe, uncertainty ±1.1° C. between −200° C. and +1000° C.), the theoretical thermal power required is close to 1770 W to obtain this constant evaporation rate of 42 g/min (with latent heat of vaporization of water=2260 J/g and heat capacity of water between 0° C. and 100° C.=4.19 J/g/° C.).

The electrical power consumed is then measured using a Voltcraft Energy check 3000 wattmeter and is 1920 W, giving an energy efficiency of 92% (1770/1920).

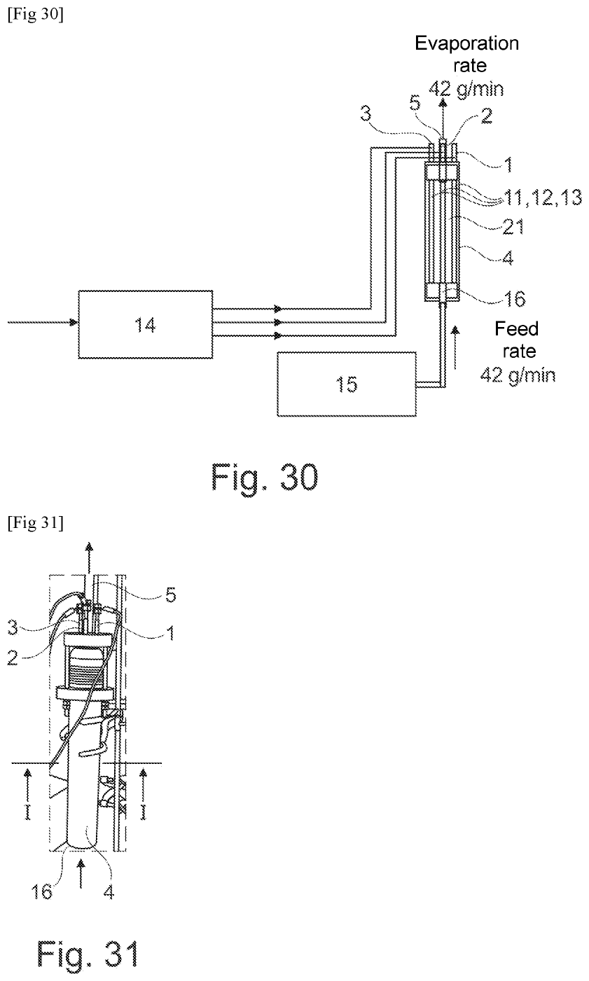

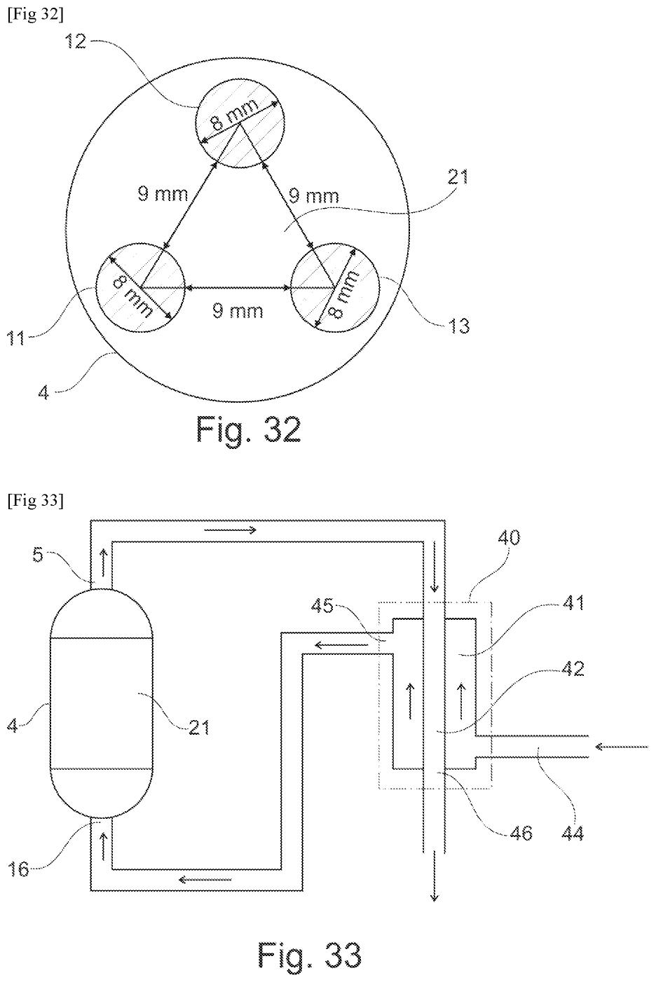

As illustrated in FIGS. 30 and 31, the invention includes a treatment zone 21 formed between three graphite electrodes 11, 12, 13, each 200 mm long and 8 mm in diameter. The electrodes 11, 12, 13 are arranged within a reactor 4 which is a polyethylene tube with a total length of 220 mm and a diameter of 35 mm, so that the treatment zone 21 has a length of 170 mm. Within the reactor 4, the electrodes 11, 12, 13 are arranged as the vertices of an equilateral triangle with a side length of 17 cm, so that the spacing between each electrode is 9 mm, as illustrated in FIG. 32.

The electrodes 11, 12, 13 are powered with a three-phase alternating current 1, 2, 3 chopped at a voltage of 130 V. The current supplied to the electrodes 11, 12, 13 has a phase alternation frequency of 3 kHz and a chopping frequency of 16 kHz. The current supplied to the electrodes 11, 12, 13 is obtained from the output of a SAKO SKI 670-2D2G-23 type frequency converter 14, whose input is powered by a mains current such as a 50 Hz single-phase alternating current at a voltage of 230 V. The frequency converter 14 used has the following input characteristics: single-phase AC 220 V 15 A/20 A 50-60 Hz, and the following output characteristics: three-phase AC 0-380 V 13 A/17 A 0-3000 Hz.

A flow of tap water similar to that used for the test with the immersion heater 19, i.e. 620 μS/cm conductivity, is circulated through the treatment zone 21 at a rate similar to the feed rate to the beaker for testing with the immersion heater, i.e. 42 g/min, using a Hirshmann Rotarus PK10-16 type peristaltic pump 15.

There is no liquid water outlet from the reactor 4 at outlet 5, only a steam outlet. This makes it possible to determine that the evaporation rate is thus equal to the feed rate to the reactor 4, i.e. 42 g/min.

For a temperature close to 25° C. for the tap water feeding the treatment zone 21 (KIMO KISTOCK KTT 310 thermometer with type K thermocouple probe, uncertainty ±1.1° C. between −200° C. and +1000° C.), the theoretical thermal power required is close to 1798 W to obtain this evaporation rate of 42 g/min.

The electrical power consumed is thus measured using a Voltcraft Energy check 3000 wattmeter at 1830 W, giving an energy efficiency of at least 98% (1798/1830), as opposed to 92% for the electrical resistance.

This comparative test clearly demonstrates the superiority of the invention over an immersion heater in terms of energy efficiency for steam production applications.

The invention also allows steam to be produced much more quickly than with an immersion heater, since it instantly vaporizes the flow of tap water passing through the treatment zone.

Open-Circuit Vapor Production

As shown in FIG. 33, the process according to the invention may allow open-circuit vapor production.

To do this, a flow of liquid, for example an aqueous liquid, to be treated, is circulated through the reactor 4 so as to vaporize it. The liquid to be treated is introduced into the reactor 4 at its inlet 16, and the steam generated escapes from the reactor 4 at its outlet 5.

The outlet 5 of the reactor 4 is connected to a condenser 40, allowing the generated steam to be transformed into liquid by heat exchange with a refrigerant fluid. Thus, the generated steam is conveyed to the condenser 40, where it is condensed by means of a refrigerant fluid, which in this case is the liquid to be treated.

The condenser 40 includes an internal circuit 42 for circulating the generated steam and an external circuit 41 for circulating the liquid to be treated, generally in the opposite direction to the internal circuit. The condenser 40 is thus said to have separate fluids, i.e. no contact between the steam and the liquid, and its operating principle is similar to that of the Liebig-West straight condenser, the Allihn ball condenser or the Graham serpentine condenser.

The circulation of the liquid to be treated in the external circuit 41 from its inlet 44 to its outlet 45 allows cooling of the internal steam circulation circuit 42, and thus condensation of said steam. The latent heat of condensation is then transferred to the liquid to be treated, allowing a heated liquid to be obtained at the outlet 45 of the external circuit 41.

The outlet 45 of the external circuit 41 is connected to the inlet 16 of the reactor 4. Thus, the heated liquid to be treated is conveyed to the reactor 4, where it is vaporized. This heating of the liquid to be treated upstream of the reactor 4 is particularly advantageous, as it improves the energy efficiency of the process.

The steam thus condensed at the outlet 46 of condenser 40 may be, for example, drinkable, purified or fresh water in the case where the aqueous liquid to be treated is, respectively, raw water, waste water or seawater/hard water.

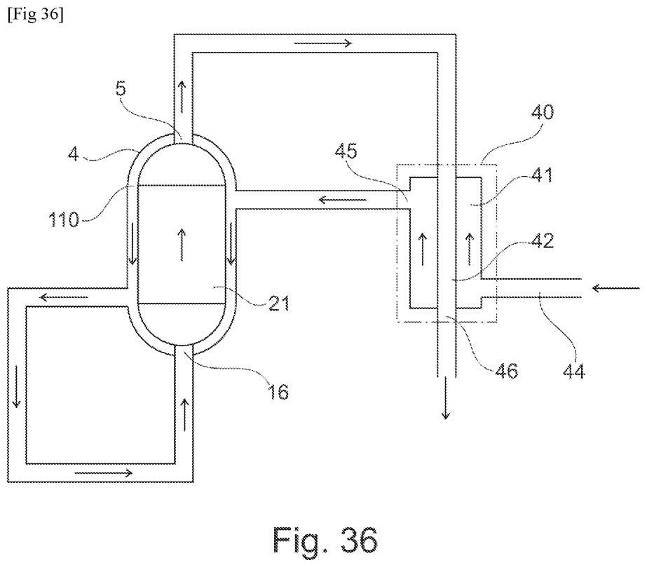

As a variant, the heated liquid to be treated coming from the outlet 45 of the external circuit 41 circulates in a double jacket 110 of the reactor 4 and is then conveyed to the inlet 16 of the reactor 4 so as to pass through the treatment zone 21, as illustrated in FIG. 36. By circulating through the double jacket 110 of the reactor 4, the liquid to be treated can pick up some of the heat generated within the treatment zone 21. This may thus allow the liquid to be treated to be further heated before passing through the treatment zone 21, and also further improve the energy efficiency of the process.

Closed-Circuit Vapor Production

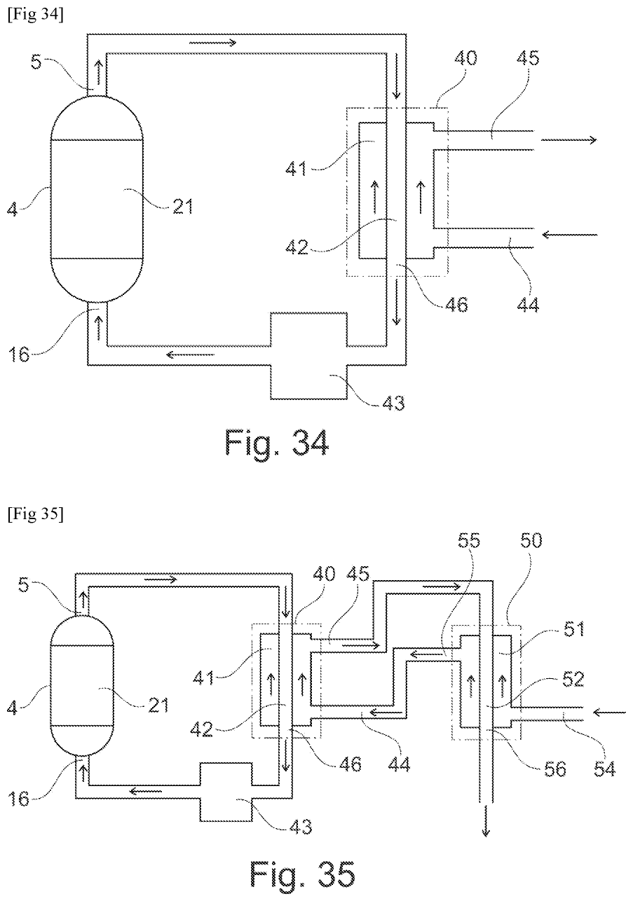

As a variant, the process according to the invention allows vapor to be produced in a closed circuit, as shown in FIGS. 34 and 35.

In the diagram shown in FIG. 34, notably an aqueous liquid, preferably deionized or purified water or aqueous ammonia, from a reservoir 43 is introduced into the reactor 4 at its inlet 16, and the steam generated escapes from the reactor 4 at its outlet 5. The steam is conveyed to the condenser 40, where it is condensed by means of a refrigerant fluid, in this case a fluid to be heated. The steam condensed at the outlet 46 of the condenser feeds the reservoir 43. The steam is thus produced in a closed circuit. The use of deionized or purified water or aqueous ammonia can limit or even eliminate deterioration of the materials constituting the reactor 4, the electrodes arranged within the reactor 4, the condenser 40, the tank 43 and the pipework, notably by oxidizing and/or corrosive agents, and thus increase their service life. Aqueous ammonia may notably be used in the case of an application of the invention to a heat pump.

The circulation of the fluid to be heated in the external circuit 41 from its inlet 44 to its outlet 45 allows the steam circulation internal circuit 42 to be cooled and thus to condense said steam. The latent heat of condensation is transferred to the fluid to be heated, allowing it to be heated. A heated fluid is thus obtained at the outlet 45 of the external circuit 41. This heated fluid may, for example, be domestic hot water.

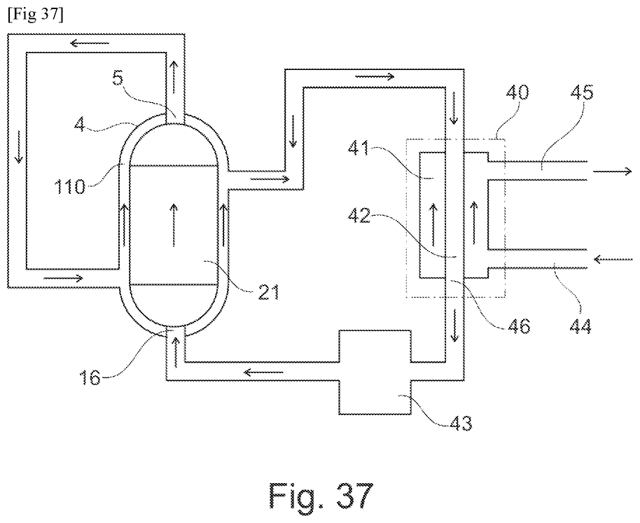

As a variant, the outlet 5 of the reactor 4 is connected to a double jacket 110 of the reactor 4 so that some or all of the steam generated circulates in the double jacket 110 before being conveyed to the condenser 40, as illustrated in FIG. 37. By circulating in the double jacket 110 of the reactor 4, the steam generated may allow the aqueous liquid to be treated within the treatment zone 21 to be reheated, thereby improving the energy efficiency of the process.

FIG. 35 represents an embodiment variant of FIG. 34, in which the refrigerant fluid circulating in the external circuit 41 of the condenser 40 is a liquid to be vaporized. Vapor is therefore generated at the outlet 45 of the external circuit 41.

The outlet 45 of the external circuit 41 of the condenser 40 is connected to a condenser 50. The vapor generated at the outlet 45 is thus conveyed to a condenser 50, where it is condensed by means of the liquid to be vaporized, which circulates within the external circuit 51 of the condenser 50 from an inlet 54 to an outlet 55. At the outlet 56 of the condenser 50, condensed vapor is obtained, and at the outlet 55 of the external circuit 51, the liquid to be vaporized is heated by capturing the latent heat of condensation of the vapor circulating within the internal circuit 52 of the condenser 50.

The outlet 55 of the external circuit 51 of the condenser 50 is connected to the inlet 44 of the external circuit 41 of the condenser 40, so that the heated liquid to be vaporized is introduced into the external circuit 41 of the condenser 40, where it is vaporized by capturing the latent heat of condensation of the vapor circulating within the internal circuit 42 of the condenser 40. As mentioned above, vapor is thus generated at the outlet 45 of the external circuit 41.

The role of the condenser 50 is thus to preheat the liquid to be vaporized, and the role of the condenser 40 is to vaporize it.

The facility represented in FIG. 35 may allow, for example, the desalination of seawater, the liquid to be vaporized then being seawater and the vapor condensed at the outlet 56 of the condenser 50 being fresh water.

### EXAMPLES OF NANOPARTICLE PRODUCTION

### Example 1

Three cylindrical copper electrodes with a length of 110 mm and a diameter of 10 mm are subjected to a voltage of between 10 V and 400 V (preferably 200 V) and an alternating current with a frequency of over 100 Hz (preferably 3000 Hz). The current waveform is square, for example.
10 ml of a copper sulfate solution (1M-CuSO₄) are first introduced into the treatment zone.
A pump (flow rate 5 ml/min) supplies purified water (resistivity 18.2 MΩ cm) to the treatment zone.
When the volume of solution to be treated is sufficient to place the electrodes in contact with the solution to be treated, an electrochemical reaction occurs and copper (Cu) nanoparticles are instantly formed in the mixture.
These nanoparticles are concentrated mainly in the solution present in the treatment zone, but also on the copper electrodes. Some of these nanoparticles are also entrained by the exiting steam.
In this example, the copper salt reacts to form nanoparticles of copper and copper oxides.

### Example 2

Three cylindrical ferric electrodes with a length of 110 mm and a diameter of 10 mm are subjected to a voltage of between 10 V and 400 V (preferably 200 V) and an alternating current with a frequency of over 100 Hz (preferably 3000 Hz).
The shape of the current is, for example, square.
10 ml of a copper sulfate solution (1M-CuSO₄) are first introduced into the treatment zone.
A pump (flow rate 5 ml/min) supplies purified water (resistivity 18.2 MΩ cm) to the treatment zone.
When the volume of solution to be treated is sufficient to place the electrodes in contact with the solution to be treated, an electrochemical reaction takes place and ferrous (Fe) nanoparticles are instantly formed in the mixture. These nanoparticles are concentrated mainly in the solution present in the treatment zone, but also on the ferric electrodes. Some of these nanoparticles are also entrained by the exiting steam.
In this example, it is the ferric electrodes that react to form iron and iron oxide nanoparticles.

### Example 3

Three cylindrical stainless steel electrodes (stainless steel 316L), 110 mm long and 10 mm in diameter, are subjected to a voltage of between 10 V and 400 V (preferably 200 V) and an alternating current at a frequency of over 100 Hz (preferably 3000 Hz). The shape of the current is, for example, square.
10 ml of a silver nitrate solution (1M-AgNO₃) are first introduced into the treatment zone.
A pump (flow rate 5 ml/min) supplies purified water (resistivity 18.2 MΩ cm) to the treatment zone.
When the volume of solution to be treated is sufficient to place the electrodes in contact with the solution to be treated, an electrochemical reaction occurs and silver (Ag) nanoparticles are instantly formed in the mixture.
These nanoparticles concentrate mainly in the solution present in the treatment zone, but also on the stainless steel electrodes. Some of these nanoparticles are also entrained by the exiting steam.
In this example, the silver salt reacts to form nanoparticles of silver and silver oxides.
The advantage of the invention when performed for the production of metallic nanoparticles is the virtually immediate production of metallic nanoparticles, in large quantities, with relatively little energy consumed. In addition, such a process is readily industrializable.
The metal nanoparticles can be produced using alternating current (of various waveforms) and at different frequencies (>100 Hz), the nanoparticles being obtained from electrochemical reactions involving the nature of the salts treated and/or the nature of the electrodes used.
The treatment zone can be subjected to laser irradiation and/or ultrasound techniques to increase the nanoparticle production yields.

1. A process for treating a liquid, with a view to heating same, producing steam, triggering a catalytic reaction, producing nanoparticles and/or concentrating at least one species present therein, in which a liquid is exposed or a flow of the liquid is circulated in at least one treatment zone formed between at least two electrodes connected to an alternating current source with a phase alternation frequency greater than or equal to 100 Hz, so as to heat, vaporize, chemically activate, produce nanoparticles and/or concentrate the liquid at least partially under the effect of the passage of current between these electrodes.

2. The process as claimed in claim 1, in which a flow of a liquid, is circulated in at least one treatment zone formed between at least two electrodes connected to an alternating current source with a phase alternation frequency greater than or equal to 100 Hz, so as to vaporize, chemically activate and/or concentrate the liquid at least partially under the effect of the passage of the current between these electrodes.

3. The process as claimed in claim 1, in which a liquid, is exposed to at least one treatment zone formed between at least two electrodes, notably electrodes connected to an alternating current source with a phase alternation frequency greater than or equal to 100 Hz, so as to produce nanoparticles under the effect of the current passing between these electrodes, the production of nanoparticles preferably corresponding to at least 10%, by mass of the metal introduced.

4. (canceled)

5. (canceled)

6. The process as claimed in claim 1, the treatment zone being formed between at least three electrodes supplied with multi-phase.

7. (canceled)

8. The process as claimed in any one of the preceding claim 1, the current flowing between at least two electrodes, one of which is a neutral electrode located in the treatment zone.

9. The process as claimed in claim 1, the electrodes being made of a chemically inert material.

10. (canceled)

11. The process as claimed in claim 1, the passage of current through the treatment zone generating a rotating and/or oscillating electric field.

12. The process as claimed in claim 11, the electric field generating Cooper pairs.

13. The process as claimed in claim 1, at least one ferromagnetic core being present within the treatment zone.

14. The process as claimed in claim 1, the alternating current source having a phase alternation frequency greater than or equal to 200 Hz, and less than or equal to 2 MHz.

15. (canceled)

16. (canceled)

17. (canceled)

18. (canceled)

19. The process as claimed in claim 1, in which the electric field strength is greater than or equal to 1 V/m.

20. The process as claimed in claim 1, in which the voltage applied between the electrodes is chosen so as to generate electric arcs and/or plasma in the liquid within the treatment zone.

21. The process as claimed in claim 1, in which at least part of the heat generated by the process is used to heat the liquid upstream of and/or within the treatment zone or to heat, or even vaporize, a fluid different from the liquid.

22. (canceled)

23. The process as claimed in claim 1, the liquid flow rate through the treatment zone being greater than or equal to 0.0001 mL/min/W delivered by an electric generator supplying the electrodes.

24. (canceled)

25. The process as claimed in claim 1, in which the liquid is heated and/or vaporized in a closed circuit.

26. The process as claimed in claim 1, the liquid being deionized or purified water or aqueous ammonia.

27. (canceled)

28. (canceled)

29. (canceled)

30. (canceled)

31. (canceled)

32. (canceled)

33. (canceled)

34. (canceled)

35. A facility for performing the process as claimed in claims, including:
a reactor including at least one liquid supply, with at least one treatment zone,
at least two electrodes arranged in the treatment zone for exposing the liquid therein to an alternating electric current with a phase alternation frequency greater than or equal to 100 Hz, so as to heat, vaporize, chemically activate, produce nanoparticles and/or concentrate the liquid at least partially under the effect of the current passing between these electrodes,
an electric generator to supply the electrodes with alternating current with a phase alternation frequency equal to or greater than 100 Hz.

36. (canceled)

37. (canceled)

38. (canceled)

39. The facility as claimed in claim 35, the electric generator being configured to generate single-phase or multi-phase alternating current.

40. (canceled)

41. The facility as claimed in claim 35, including at least one energy recovery system configured to allow condensation of at least part of the vapor produced, recovery of at least part of the latent heat of condensation and use of at least part of the recovered latent heat of condensation to heat the liquid upstream of and/or within the treatment zone or to heat or vaporize a fluid different from the liquid.

42. (canceled)
